(19) United States
(12) Patent Application Publication
(10) Pub. No.: US 2011/0207478 A1
(43) Pub. Date: Aug. 25, 2011

(54) LOCATION BASED MULTIMEDIA MESSAGE SERVICE GENERATING SYSTEM AND METHOD THEREOF

(76) Inventors: Chien-Yu Pan, Taipei (TW); Chia-Ching Chen, Taipei (TW); Chien-Wei Huang, Taipei (TW); Jimmy Wu, Taipei (TW)

(21) Appl. No.: 12/709,617

(22) Filed: Feb. 22, 2010

(51) Int. Cl. H04W 4/02; H04W 4/14

(52) U.S. Cl. 455/456.3; 455/466

(57) ABSTRACT

The present invention discloses a location based MMS generating system and method thereof. The generating system previously stores multimedia contents, each of which is related to a corresponding location. When a user's MMS request is triggered, a location service request is sent to LoCation service (LCS) server of the 3G telecommunication network to obtain the user's location. Then the multimedia contents related to the user's location are extracted and further packaged to a MMS format. The MMS generating system sends the MMS to the user. Therefore, the user may immediately receive the useful MMS.

### BACKGROUND OF THE INVENTION

1. Field of the Invention

The present invention relates to the filed of multimedia Massaging in telecommunication networks, and more particularly to a Method and system of generating location based MMS.

2. Description of Related Art

European Telecommunications Standard Institute (ETSI) 3rd Generation Partnership Project (3GPP) Technical Specification 23.140 entitled “Digital cellular telecommunications system (Phase 2+); Universal Mobile Telecommunications System (UMTS); Multimedia Messaging Service (MMS); Functional description; Stage 2” (a.k.a. ETSI TS 123 140 V6.10.0 (2005-06) and 3GPP TS 23.140 version 6.10.0 Release 6) and 3rd Generation Partnership Project Two (3GPP2) Technical Specification X.P0016-200, “Multimedia Messaging Service; Stage 2 Functional Description” define a non-realtime Multimedia Messaging Service (MMS) which has been widely adopted by network operators (both GSM and CDMA), service providers, and terminal, switch and database manufacturers. The 3GPP2 specification is an adaptation of the 3GPP TS 23.140 technical specification.

With reference to FIG. 6, a schematic diagram of a MMS Reference Architecture used in the 3GPP TS 23.140 technical specification is shown and the MMS Reference Architecture has a MMS server (50) and a plurality of network servers. The MMS server (50) has a relay unit (502), a server unit (501) and a plurality of interfaces (MM1 to MM11). The first interface (MM1) is used as the reference point between the MMS user agent (60) and the MMS server (50). The second interface (MM2) is used as the reference point between the server unit (501) and relay unit (502). The third interface (MM3) is used as the reference point between the MMS server (50) and external (legacy) messaging systems, such as external E-mail server, external Fax server etc. The fourth interface (MM4) is used as reference point between the MMS server (50) and another MMS server that is within another MMSE. The fifth interface (MM5) is used as the reference point between the MMS server (50) and the Home Location Register (HLR). The sixth interface (MM6) is used as the reference point between the MMS server (50) and the MMS User Database. The seventh interface (MM7) is used as the reference point between the MMS server (50) and MMS VAS Application. The eighth interface (MM8) is used as the reference point between the MMS server (50) and a post-processing system. The ninth interface (MM9) is used as the reference point between the MMS server (50) and the online charging system. The tenth interface (MM10) is used as the reference point between the MMS server (50) and a Messaging Service Control Function (MSCF). The eleventh interface (MM11) is used as the reference Point between the MMS server (50) and a Transcoding Platform.

With reference to FIG. 7, an architectural diagram of a MMS system is shown. The MMS server (50) links to a MMS user agent (60), MMS storage (51), an external E-mail server (52) and a Legacy Wireless Messaging System (53) having a capability of calling and massaging through the corresponding interfaces (MM1 to MM11). In addition, the MMS server (50) may link to another MMS server (50a) to use as a medium between telecommunication networks (A, B) so the MM from the originator MMS user agent (60) may be transmitted to the target MMS user agent (60a) through the target MMS user agent's MMS server (50a).

With further reference to FIG. 8, an end to end MMS transaction is executed by the above MMS server (50) to transmit one MM from originator MMS user agent (60) to the target MMS user agent (60a).

When the MMS server (50) receives a MM-SEND.REQ from the originator MMS user agent (60), the MMS server (50) sends a M-SEND.CONF to the originator MMS user agent (60) and obtains the MM from the originator MMS user agent (60). Then the MMS server (50) automatically sends an M-NOTIFICTION.IND to the target MMS user agent (60a) and waits to receive a M-NOTIFYRESP.IND from the target MMS user agent (60a). When the M-NOTIFYRESP.IND and the WSP/HTTP GET.REG are received, the MMS server (50) sends an M-RETRIEVE.CONF including the MM to the target MMS user agent (60a). When the target MMS user agent (60a) successfully receives the MM, an M-ACKNOWLEDGE.IND is sent to the MMS server (50) and then the MMS server (50) sends an M-DELIVERY.IND to the originator MMS user agent (60) and the M-DELIVERY.IND is used as a delivery report.

Based on the foregoing description, in the end to end MMS transaction the MM data has to be stored in the MMS storage (51) linking to the MMS server (50). The MM data is packaged to the MMS format and then sent it to the target MMS user agent (60a) when the MMS server (50) received the MMS request from the target MMS user agent (60a). Therefore, the MMS system have to previously stores the MM data therein before the MM is sent to the target MMS user agent (60).

Since 3G mobile phones are more and more popular, using 3G mobile phone to review MMS is common. Many businessmen create MM including commercial advertisement data to sent target MMS user agent through the MMS system. With reference to FIG. 9, a time sequence diagram of a signal VASP to multi-end MMS transaction is shown and the signal VASP to multi-end MMS transaction is executed by the above MMS system. The seventh interface (MM7) of the MMS server links to a Value Added Service Provider (VASP). When the VASP sends a MM7_submit.REQ to the MMS server, the MMS server responses the VASP a MM7_submit.RES to the VASP. Since the VASP would like to send the commercial advertisement data to multiple target MMS user agents, the MMS server sends the MM1_notification.REQ to each target MMS user agent in sequence. For example, when the first MMS user agent receives the MM1_notification.REQ, the first target MMS user agent sends back a MM1_notification.RES including rejected information. When the MMS server sends the MM1_notification.REQ to the second target MMS user agent, the second MMS user agent may send a MM1_notification.RES including deferred information to the MMS server. The MMS Server will send a MM1_retrieve.RES including the MM to the second target MMS user agent after receiving a MM1_retrieve.REQ from the second target MMS user agent. If the MM is successfully received by the second target MMS user agent, a MM1_acknowledgement.REQ is sent to the MMS server. The MMS server sends a MM7_delivery_report.REQ to the VASP and then ends this procedure after receiving the MM7_delivery_report RES from VASP.

In general, the VASP has to send commercial advertisement data to the MMS server and the MMS automatically contact each of the target MMS user agents and send the MM including the commercial advertisement data to multiple target MMS user agents. Therefore, the commercial advertisement data has to previously send and store inside the MMS server and send the MM including commercial advertisement data to each of the target MMS user agents sends the request until receiving the request from the corresponding MMS user agents.

Since the MMS server only has receiving and transmitting MMS functions, the content of MM and number of the MM are not filtered by the MMS server. Therefore the target MMS user agent receives many useless MMs, such as garbage e-mails in 3G telephone.

To overcome the shortcomings, the present invention provides a Method and system of generating location based MMS to mitigate or obviate the aforementioned problems.

### SUMMARY OF THE INVENTION

The main objective of the present invention is to provide a Method and system of generating location based MMS. The MMS system sends useful MM to target MMS user agent according to the location of the target MMS user agent to file the MM for the target MMS user agent.

The present invention discloses a location based MMS generating system and method thereof. The generating system previously stores multimedia contents, each of which is related to a corresponding location. When a user's MMS request is triggered, a location service request is sent to LoCation service (LCS) server of the 3G telecommunication network to obtain the user's location. Then the multimedia contents related to the user's location are extracted and further packaged to a MMS format. The MMS generating system sends the MMS to the user. Therefore, the user may immediately receive the useful MMS.

Other objectives, advantages and novel features of the invention will become more apparent from the following detailed description when taken in conjunction with the accompanying drawings.

### BRIEF DESCRIPTION OF THE DRAWINGS

FIG. 1 is an architectural diagram of a MMS generating system in accordance with the present invention;

FIG. 2 is a time sequence diagram of generating MMS in accordance with the present invention;

FIG. 3 is a flow chart of a MMS generating method in accordance with the present invention;

FIG. 4 is a logical architectural diagram of a general LoCation service (LCS) server;

FIG. 5 is a time sequence diagram of FIG. 4;

FIG. 6 is an architectural diagram of a conventional MMS Reference Architecture used in the 3GPP TS 23.140 technical specification;

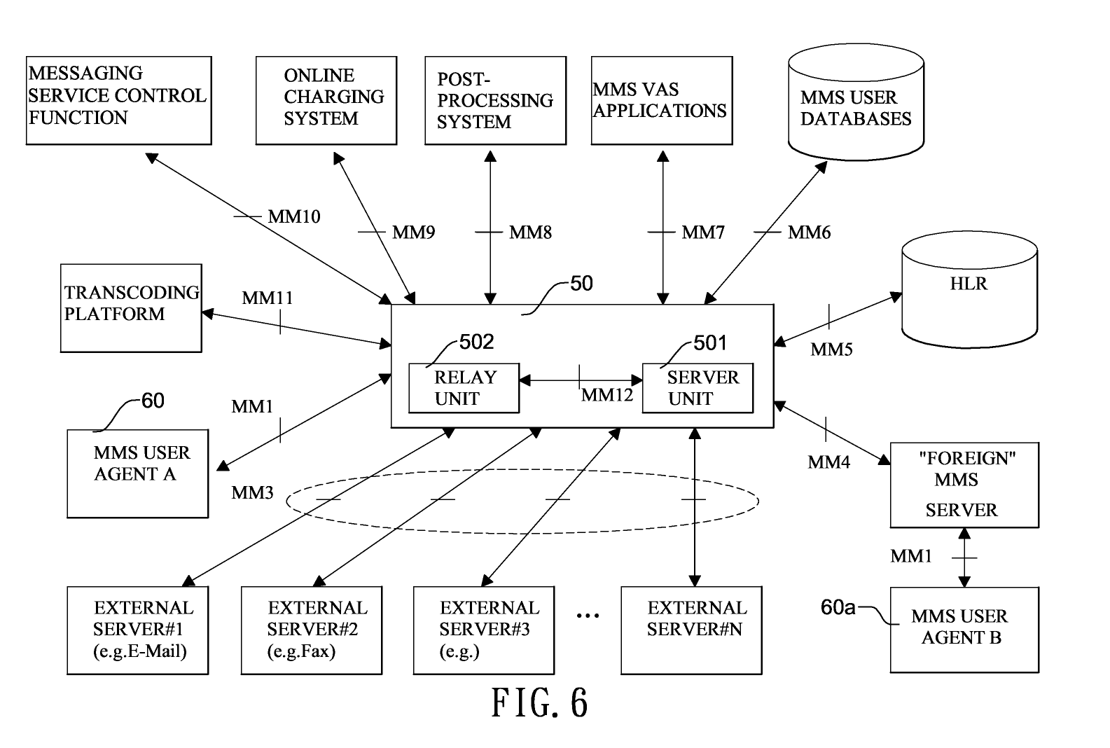

FIG. 7 is an architectural diagram of a MMS system in accordance with the prior art;

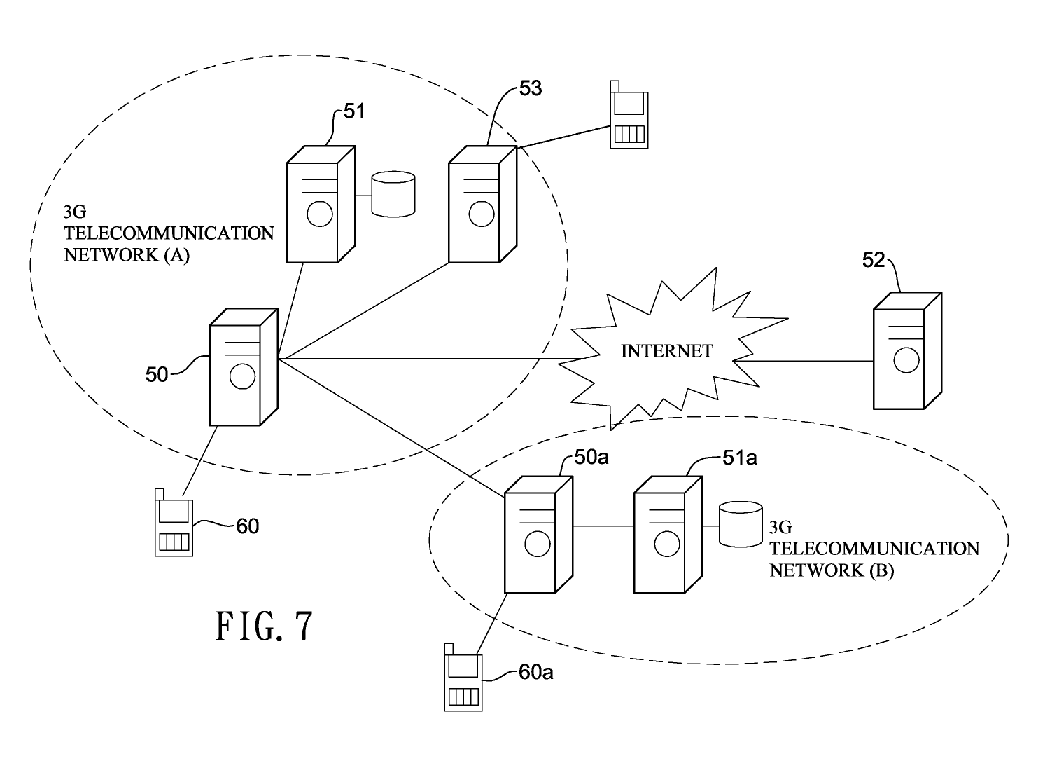

FIG. 8 is a time sequence of an end to end MMS transaction in accordance the prior art; and

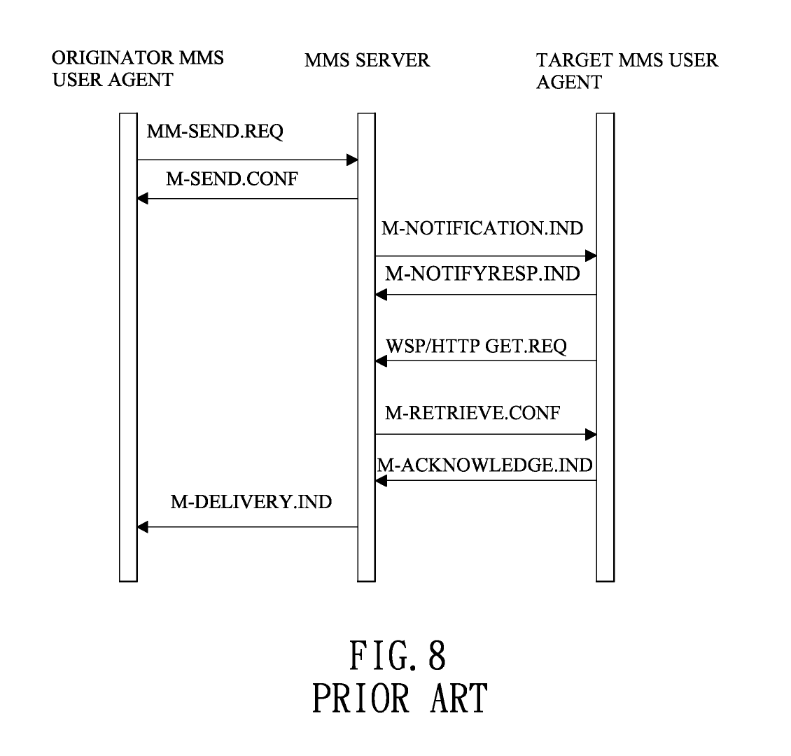

FIG. 9 is a time sequence of an end to end MMS transaction in accordance the prior art.

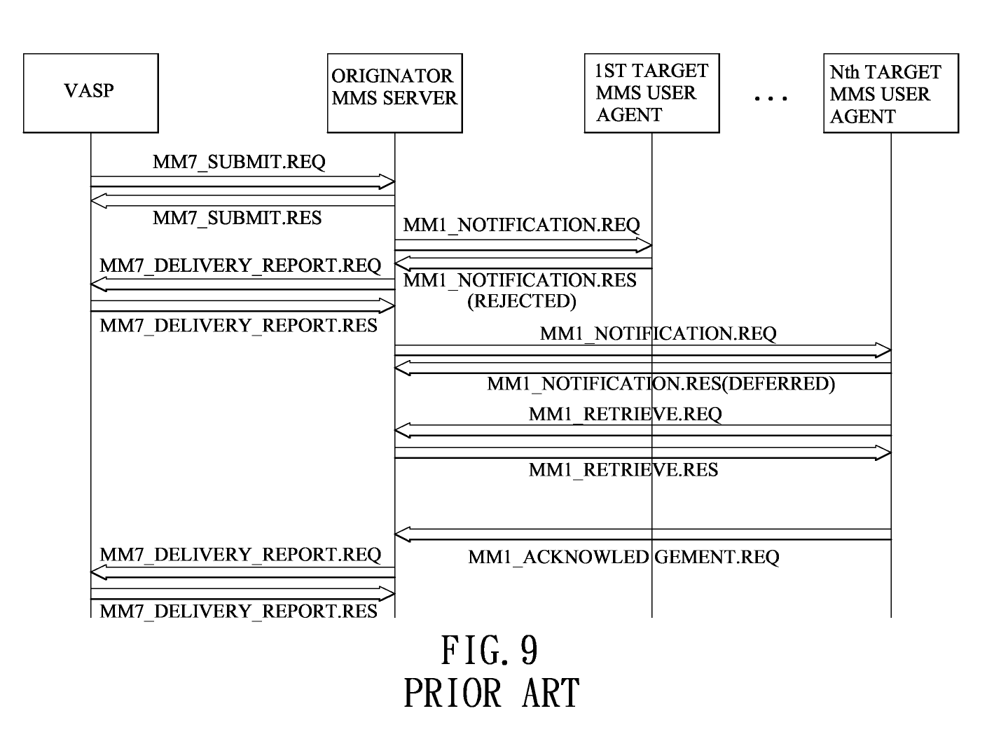

### DETAILED DESCRIPTION OF THE PREFERRED EMBODIMENT

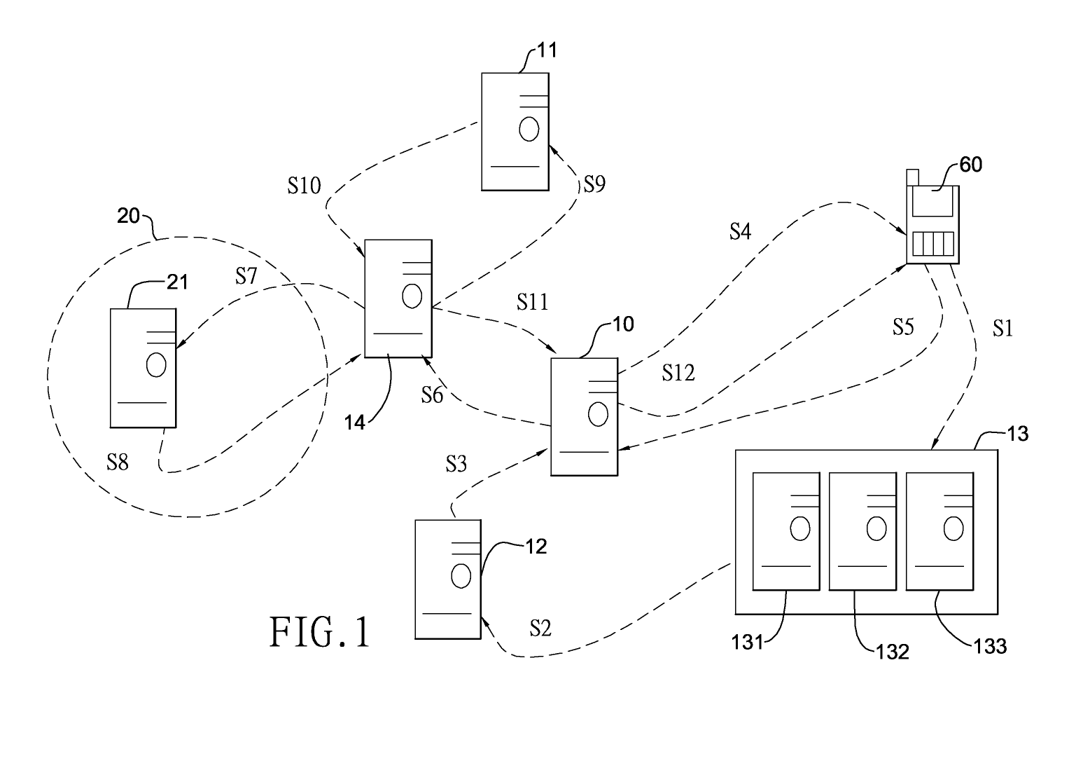

With reference to FIG. 1, a MMS generating system has a MMS server (10), a location service client (14), a MM database server (11), a service server (12) and a plurality of MMS triggering servers (13).

The MMS server (10) has an integrating service interface, a MMS packaging interface and a first interface (MM1). The first interface (MM1) is used as the reference point between the MMS user agent (60) and the MMS server (10).

The location service client (14) links to the MMS server (10) and has a location service interface (not shown). The location service client (14) is used to link a LoCation service (LCS) server so the location service client (14) is an external location service client of the LCS server (21) in 3G telecommunication network (20).

The MM database server (11) links to the location service client (14) and asks the LCS server (21) a location information of the target MMS user agent (60) through the location service client (14). The MM database service (11) stores multiple multimedia content having texts, photographs, films etc.

The service server (12) links to the integrating service interface of the MMS server (10).

The MMS triggering servers (13), each of which links to the service server (12) and sends a MMS triggering request to the service server (12) if the MMS triggering server (13) is triggered. In preferred embodiment, the MMS triggering server (13) may be a two-way short massage service (SMS) server (131), Interactive Voice Response (IVR) server (132) or a web trigger server (133).

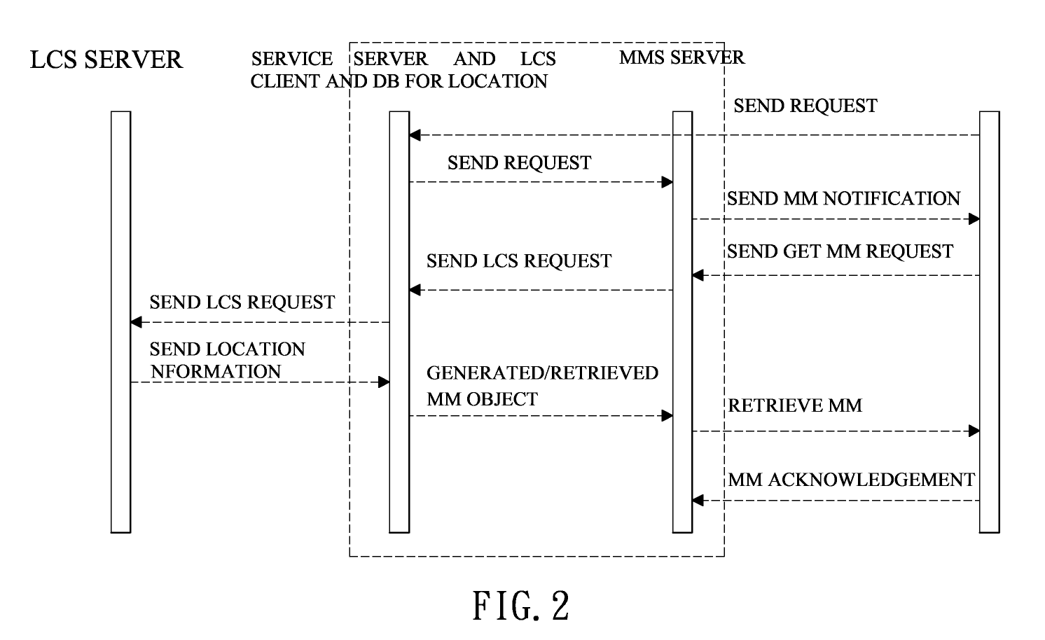

With further reference to FIG. 2, using the IVR server (132) as an example to further describe a time sequence of generating MMS by the MMS generating system.

When a user uses mobile phone to dial the IVR server (132) to ask a voice service (S1), the IVR server (132) triggers a MMS service and sends a MMS request to the MMS server (10) through the service server (12) at the time (S2). When the integrating service interface of the MMS server (10) receives the MMS request (S3), the MMS server (10) sends a MMS notification to the user's mobile phone (S4) and then waits to receive the user's response. When the MMS server (10) receives the user's response (S5), the MMS server (10) sends a location service request to the LCS server (21) (S7) through the location service client (11) (S6).

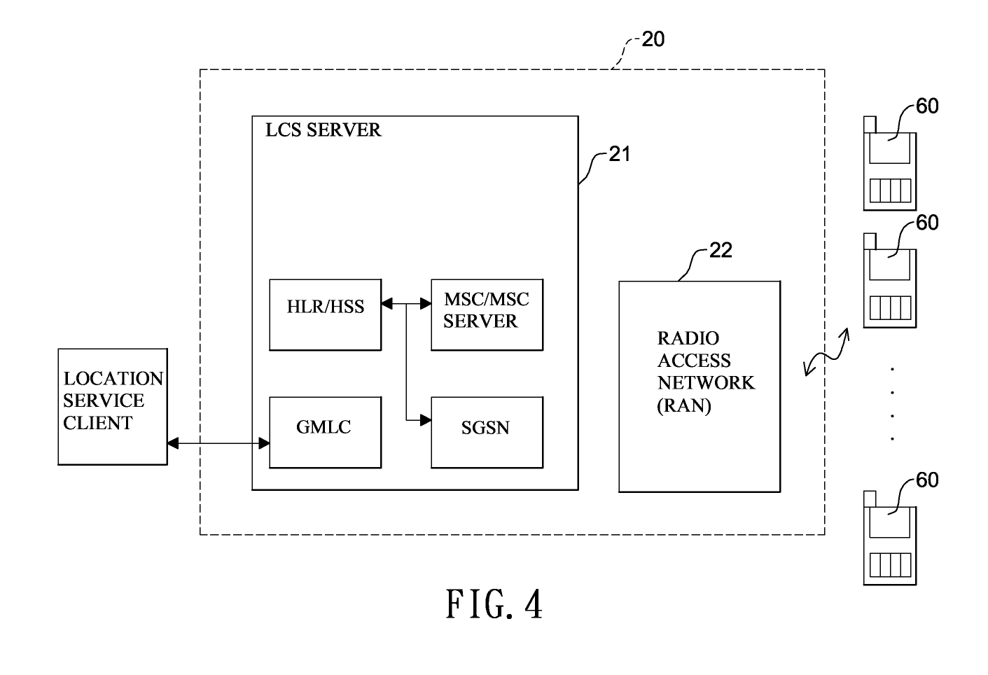

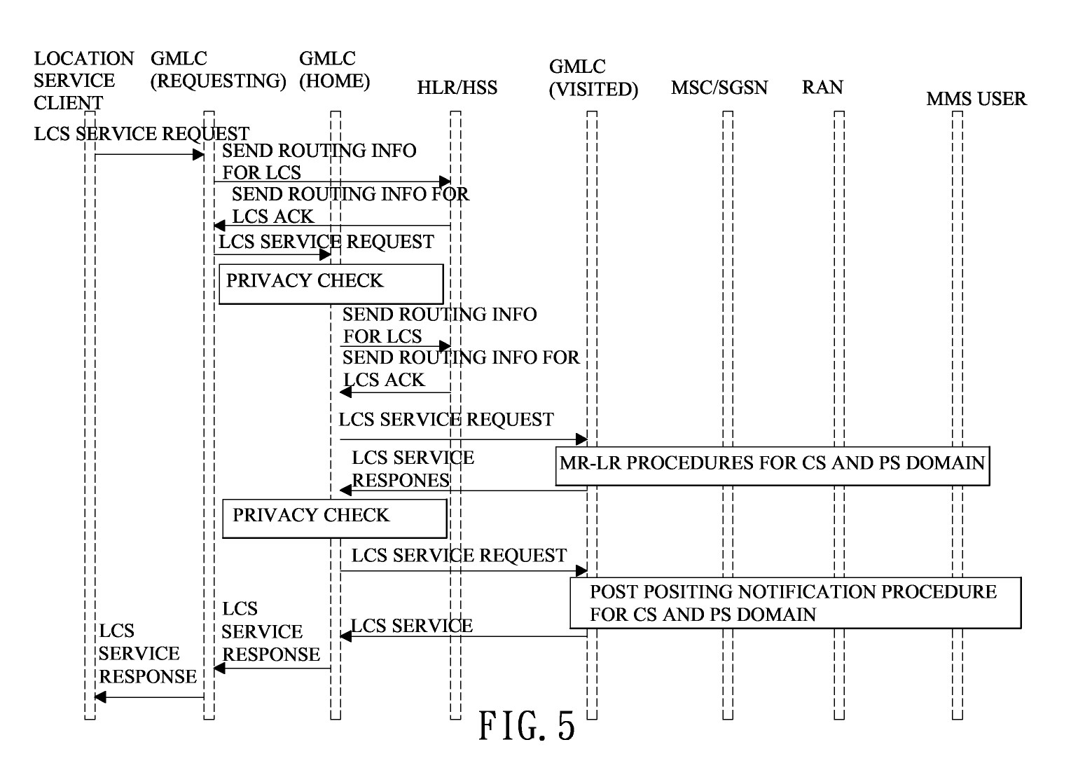

With further reference to FIGS. 4 and 5, since the LCS server (21) communicates with the user's mobile phone through the radio access network (RAN) (22), the RAN (22) executes a handshaking procedure with the user's mobile phone and then generates a location service response including the user's location. Therefore, the location service client (14) will receive the location service response from the LCS server (21) after the location service request (S8). The location of the user is obtained by the location service client (14) and then the location service client (14) sends the location to the MM database server (11) (S9). The MM database server (11) filters and extracts the multimedia contents related to the location and then sends the location related multimedia contents to the MMS packaging interface of the MMS server (10) through the location service client (14) (S10, S11). The MMS packaging interface packages the location related multimedia contents to a MMS format and generates a MMS. The MMS server (10) sends the MM to the user's mobile phone (S12). Therefore, the user will receive the location related MM after one of the MMS triggering server is triggered.

Based on the foregoing description, the MMS generating system in accordance with the present invention may link to the LCS server of the 3G telecommunication network to provide the MMS to the user according the user's location. Therefore, the user may immediately receive the useful MMS. The MMS generating system easily provides the user's MMS including commercial advertisement data corresponding to the user's location.

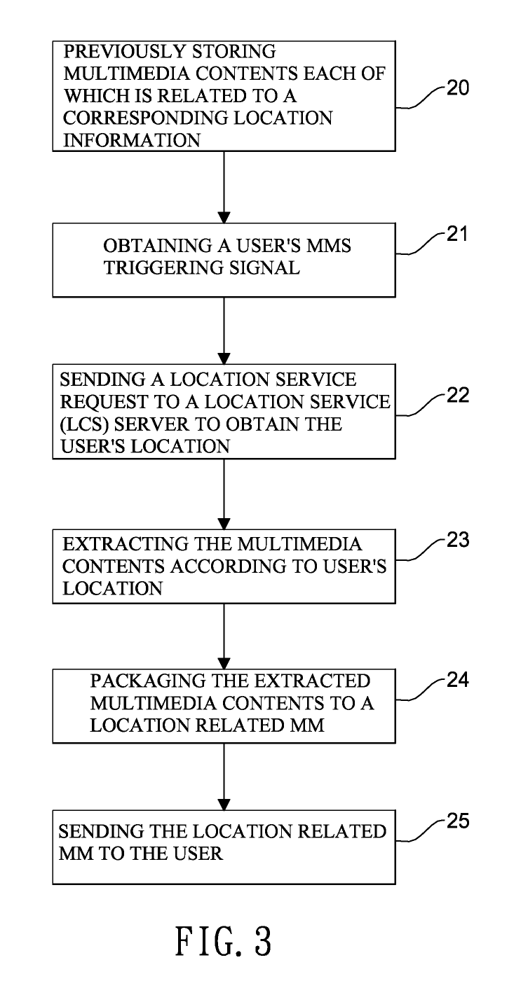

With reference to FIG. 3, a flow chart of the MMS generating method in accordance with the present invention is shown and the method has following steps of:

(a) previously storing multimedia contents each of which is related to a corresponding location information, wherein the multimedia content may be text, photograph or films (20);

(b) obtaining a user's MMS triggering signal (21);

(c) sending a location service request to an LCS server to obtain the user's location (22);

(d) extracting the multimedia contents according to user's location (23);

(e) packaging the extracted multimedia contents to a location related MM (24); and

(f) sending the location related MM to the user (25).

Based on the foregoing description, the MMS generating method is executed by triggering a MMS request and filters multimedia contents according to the user's location and then generates the location related MM to the user. Therefore, the user immediately and easily receives location related MM.

Even though numerous characteristics and advantages of the present invention have been set forth in the foregoing description, together with details of the structure and function of the invention, the disclosure is illustrative only. Changes may be made in detail, especially in matters of shape, size, and arrangement of parts within the principles of the invention to the full extent indicated by the broad general meaning of the terms in which the appended claims are expressed.

What is claimed is:

1. A location based MMS generating system, comprising:
a MMS server having an integrating service interface, a MMS packaging interface and a first interface, wherein the first interface (MM1) is used as the reference point between the MMS user agent and the MMS server;
a location service client linking to the MMS server and a LoCation service (LCS) server, and having a location service interface, wherein the location service client is an external location service client of the LCS server in 3G telecommunication network;
a MM database server linking to the location service client and asks the LCS server a MMS user's location information;
a service server linking to the integrating service interface of the MMS server;
a MMS triggering server, each of which links to the service server and sends a MMS triggering request to the service server if the MMS triggering server is triggered.

2. The location based MMS generating system as claimed in claim 1, wherein the multimedia content has texts, photographs or films.

3. The location based MMS generating system as claim in claim 1, wherein the MMS triggering server is a two-way short massage service server, an interactive voice response server or a web trigger server.

4. The location based MMS generating system as claim in claim 2, wherein the MMS triggering server is a two-way short massage service server, an interactive voice response server or a web trigger server.

5. A location based MMS generating method, comprising steps of:
(a) previously storing multimedia contents each of which is related to a corresponding location information;
(b) obtaining a user's MMS triggering signal;
(c) sending a location service request to a LoCation service (LCS) server to obtain the user's location;
(d) extracting the multimedia contents according to user's location;
(e) packaging the extracted multimedia contents to a location related MM; and
(f) sending the location related MM to the user.

6. The location based MMS generating method as claimed in claim 5, wherein the multimedia content has texts, photographs or films.

7. The location based MMS generating method as claimed in claim 5, wherein the user's MMS triggering signal is generated by a two-way short massage service server.

8. The location based MMS generating method as claimed in claim 6, wherein the user's MMS triggering signal is generated by a two-way short massage service server.

9. The location based MMS generating method as claimed in claim 5, wherein the user's MMS triggering signal is generated by an interactive voice response server.

10. The location based MMS generating method as claimed in claim 6, wherein the user's MMS triggering signal is generated by an interactive voice response server.

11. The location based MMS generating method as claimed in claim 5, wherein the user's MMS triggering signal is generated by a web trigger server.

12. The location based MMS generating method as claimed in claim 6, wherein the user's MMS triggering signal is generated by a web trigger server.
